(19) United States
(12) Patent Application Publication
(10) Pub. No.: US 2024/0034243 A1
(43) Pub. Date: Feb. 1, 2024

(54) ROOF CROSSBAR BRACKET

(71) Applicant: Jiangxi Senmu Technology Co.,Ltd, Shangrao (CN)

(72) Inventor: XIONG YAO, Shangrao (CN)

(21) Appl. No.: 18/365,264

(22) Filed: Aug. 4, 2023

Related U.S. Application Data
(63) Continuation of application No. PCT/CN2022/111401, filed on Aug. 10, 2022.

(30) Foreign Application Priority Data
Aug. 1, 2022 (CN) 202210915842.4

(51) Int. Cl. B60R 9/052; B60R 9/045

(52) U.S. Cl. CPC B60R 9/052; B60R 9/045

(57) ABSTRACT

The present disclosure provides a roof crossbar bracket, which includes a crossbar, a clamping device installed at both ends of the crossbar and being capably of adjusting a distance, and a shell partially wrapping the clamping device, where the clamping device includes a bracket, a hook mechanism installed on the bracket, and a locking mechanism; where the hook mechanism includes a base plate installed below the bracket, a mounting plate fixedly installed within the bracket, and a hook plate movably installed with the mounting plate, the hook plate is located on one side of the base plate, and a first adjustment component for adjusting an angle between the hook plate and the mounting plate is provided between the hook plate and the mounting plate, and a second adjustment component for adjusting an installation height of the hook plate on the mounting plate.

### CROSS-REFERENCE TO RELATED APPLICATIONS

This application is a continuation of International Application No. PCT/CN2022/111401, filed on Aug. 10, 2022, which claims priority to Chinese Patent Application No. 202210915842.4, filed with the China National Intellectual Property Administration on Aug. 1, 2022, titled “ROOF CROSSBAR BRACKET”, both of which are hereby incorporated by reference in their entireties.

### TECHNICAL FIELD

The present disclosure relates to the field of car accessories technologies, and in particular, to a roof crossbar bracket.

### BACKGROUND

There are generally two types of cars on the existing market, one is that there is a side rail on both sides of a roof, and the other is that there is no side rail on the roof. In order to place luggage on the roof without a side rail, a luggage bracket is needed to be installed on the car. However, the size and shape of the roof of different cars vary greatly, and there is a problem of mismatching size when selecting a luggage bracket.

Thus, a research and development of a roof luggage bracket for solving the problem of mismatching between the luggage bracket and the roof of the car has become an urgent problem for skilled people in the art.

### SUMMARY

In order to overcome the shortcomings of the prior art, the present disclosure provides a roof crossbar bracket with good universality, convenient adjustment, and high operation reliability.

The technical solution of the present disclosure is a roof crossbar bracket, which includes a crossbar, a clamping device installed at both ends of the crossbar and being capably adjusting a distance, and a shell partially wrapping the clamping device, where the clamping device includes a bracket, a hook mechanism installed on the bracket, and a locking mechanism;
where the hook mechanism includes a base plate installed below the bracket, a mounting plate fixedly installed within the bracket, and a hook plate movably installed with the mounting plate, the hook plate is located on one side of the base plate, a first adjustment component for adjusting an angle between the hook plate and the mounting plate is provided between the hook plate and the mounting plate, and a second adjustment component for adjusting an installation height of the hook plate on the mounting plate.

In an embodiment of the present disclosure, an upper surface of the base plate is provided with a mounting member that is vertically arranged, the mounting member is rotatably installed at a bottom of the bracket, and a lower surface of the base plate is provided with a soft pad.

In an embodiment of the present disclosure, a third bolt and a third nut for connecting the mounting member and the bracket are provided between a bottom of the mounting member and the bracket, where the third nut is a self-locking nut or a welding nut.

In an embodiment of the present disclosure, an upper end of the mounting plate is provided with a first insertion block and both side of the mounting plate are provided with a respective second insertion block, and an upper surface of the bracket is provided with a first slot that corresponds to the first insertion block, and both sides of the bracket are provide with a respective second slot that corresponds to the second insertion block, the mounting plate and the bracket are fixed by welding after the mounting plate being insertion-fit with the bracket.

In an embodiment of the present disclosure, the hook plate includes a straight plate portion located at an upper end thereof end and a claw portion located at a lower end thereof, the second adjustment component includes a strip groove and a second bolt, and the strip groove is vertically arranged on the straight plate portion, the second bolt passes through the strip groove and is thread-fit with the mounting plate.

In an embodiment of the present disclosure, a gasket is provided between the second bolt and the strip groove, and a side surface where the gasket contacts with the strip groove is a spherical surface and a surface where the gasket contacts with the second bolt is a planar surface.

In an embodiment of the present disclosure, the first adjustment component includes a first bolt that is thread-fit with the upper end of the straight plate portion, an end of the first bolt is in contact-fit with a side wall of the mounting plate, the side wall of the mounting plate is inclined, and the end of the first bolt is a spherical surface, and the mounting plate is provided with a groove that is in contact-fit with the end of the first bolt.

In an embodiment of the present disclosure, a side wall of the straight plate portion is provided with a first nut that is fixedly installed and is thread-fit with the first bolt, and the side wall of the mounting plate is provided with a second nut that is fixedly installed and is thread-fit with the second bolt.

In an embodiment of the present disclosure, the shell includes a front cover plate and a rear cover plate, where one side of the front cover plate is provided with a locking component, and a position of the rear cover plate corresponding to the locking component is provided with a limit plate, and the limit plate is provided with a passing hole, a circumferential of an end of the locking component is provided with a first stepped platform that extends outwardly, the locking component has a first state where the first stepped platform passes through the limit plate after being aligned with the passing hole, and a second state where the first stepped platform does not pass through the limit plate after being misaligned with the passing hole.

In an embodiment of the present disclosure, another side of the front cover plate is provided with a second stepped platform, and another side of the rear cover plate is provided with a second groove that is snap-fit with the second stepped platform;
a position of the rear cover plate corresponding to the mounting plate is provided with an avoidance groove.

The beneficial effect of the present disclosure is that the hook mechanism in the technical solution can achieve a function of adapting the roof bracket of different cars by adjusting a relative position between the hook plate and the mounting plate. The base plate is pressed onto a roof surface, and the hook plate hooks onto a hook groove of a door frame or a door edge. The base plate and hook plate cooperate with each other to firmly install the hook mechanism on both sides of the roof. In additionally, by adjusting a height and a tilt angle of the hook plate through the first adjustment component and second adjustment component, the hook mechanism is adapted to rooves of different models of cars, which has advantages of good universality, convenient adjustment, and high operation reliability.

### BRIEF DESCRIPTION OF DRAWINGS

FIG. 1 is a structural schematic diagram of a roof crossbar bracket of an embodiment of the present disclosure.

FIG. 2 is a structural schematic diagram of a clamping device of an embodiment of the present disclosure.

FIG. 3 is a structural schematic diagram of a hook plate and a mounting plate of an embodiment of the present disclosure.

FIG. 4 is a schematic diagram of a split structure of the hook plate and the mounting plate of an embodiment of the present disclosure.

FIG. 5 is a structural schematic diagram of the clamping device in another angle of an embodiment of the present disclosure.

FIG. 6 is a structural schematic diagram of the bracket and mounting plate of an embodiment of the present disclosure.

FIG. 7 is a structural schematic diagram of a front cover plate of an embodiment of the present disclosure.

FIG. 8 is a structural schematic diagram of a rear cover plate of an embodiment of the present disclosure.

FIG. 9 is a structural schematic diagram of various states of a hook mechanism of an embodiment of the present disclosure.

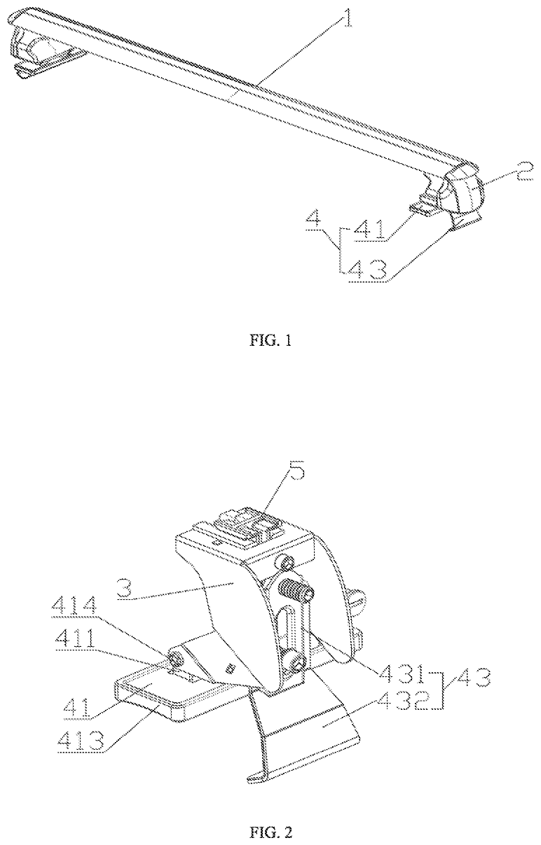

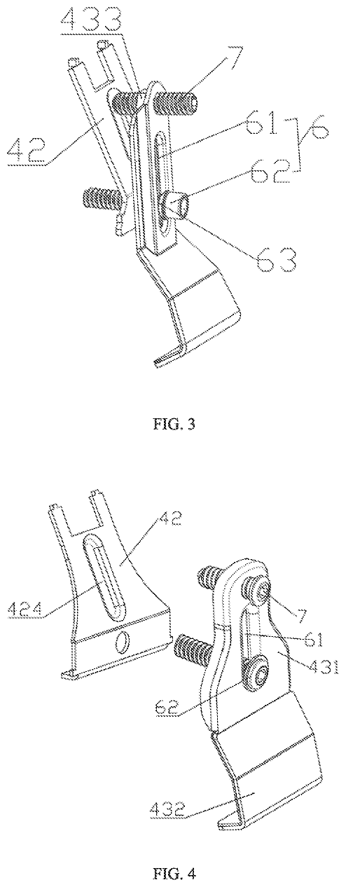

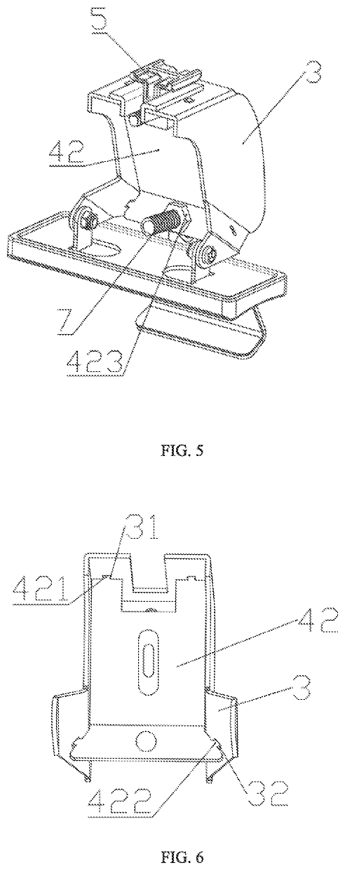

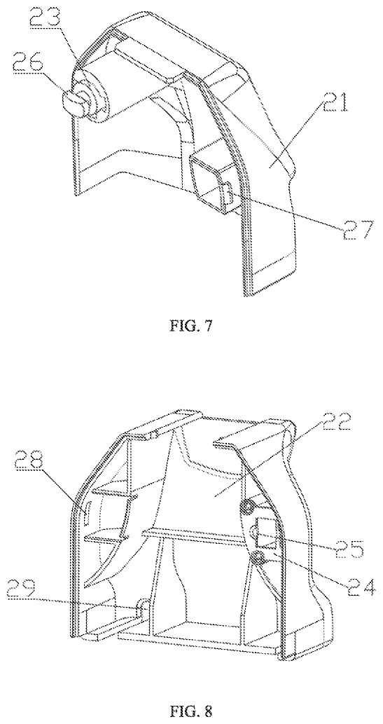

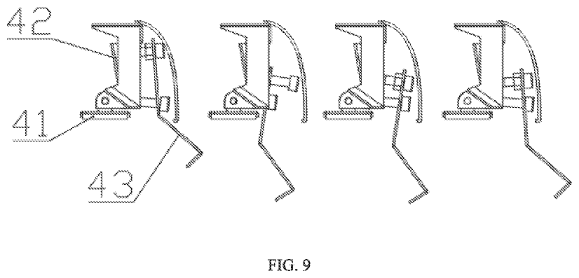

### DETAILED DESCRIPTION

The following is a further explanation of the embodiments of the present disclosure in combination with the drawings.

As shown in the drawings, a roof crossbar bracket includes a crossbar 1, a clamping device installed at both ends of the crossbar 1 and being capably adjusting a distance, and a shell 2 partially wrapping the clamping device. The clamping device includes a bracket 3, a hook mechanism 4 installed on the bracket 3, and a locking mechanism 5; the hook mechanism 4 includes a base plate 41 installed below the bracket 3, a mounting plate 42 fixedly installed within the bracket 3, and a hook plate 43 movably installed with the mounting plate 42. The hook plate 43 is located on one side of the base plate 41, a first adjustment component for adjusting an angle between the hook plate and the mounting plate is provided between the hook plate and the mounting plate, and a second adjustment component for adjusting an installation height of the hook plate 43 on the mounting plate 42.

The hook mechanism in the technical solution can achieve a function of adapting the roof bracket of different cars by adjusting a relative position between the hook plate and the mounting plate. The base plate is pressed onto a roof surface, and the hook plate hooks onto a hook groove of a door frame or a door edge. The base plate and hook plate cooperate with each other to firmly install the hook mechanism on both sides of the roof. In additionally, by adjusting a height and a tilt angle of the hook plate through the first adjustment component and second adjustment component, the hook mechanism is adapted to rooves of different models of cars, which has advantages of good universality, convenient adjustment, and high operation reliability.

In addition, the crossbar and locking mechanism in this embodiment have been disclosed in a patent of CN 2022210581133A and will not be further elaborated here.

An upper surface of the base plate 41 is provided with a mounting member 411 that is vertically arranged, the mounting member 411 can be rotatably installed at a bottom of the bracket 3, and a lower surface of the base plate 41 is provided with a soft pad 413.

A third bolt 414 and a third nut 412 for connecting the mounting member 411 and the bracket 3 are provided between a bottom of the mounting member 411 and the bracket 3. The third nut 412 is a self-locking nut or a welding nut, and the base plate is placed on roof surface. Due to a rotatable connection between the mounting member and the bracket, the base plate will automatically adjust the tilt angle and adapt itself to the roof surface. After the crossbar is installed in place and the hook plate is installed in place, the base plate will automatically be fixed, and the base plate automatically fits itself onto the roof surface.

There are at least two implementation modes of the rotatable connection between the base plate and the bracket of the present disclosure. Implementation mode 1: the third nut is a self-locking nut; implementation mode 2: the third nut is a common nut, which is welded to the mounting member. After one end of the third bolt is threaded to the common nut, the other end of the third bolt will be blocked by the shell; the above two implantation modes can ensure that the third nut will not be detached from and third bolt, thereby, effectively ensuring an effective connection between the base plate and the bracket.

The soft pad can prevent a hard contact and protect a paint surface of the roof.

An upper end of the mounting plate 42 is provided with a first insertion block 421 and both sides of the mounting plate 42 are provided with a respective second insertion block 422. An upper surface of the bracket 3 is provided with a first slot 31 that corresponds to the first insertion block 421, and both sides of the bracket are provided with a respective second slot 32 that corresponds to the second insertion block 422. The mounting plate 42 and the bracket 3 are fixed by welding after the mounting plate 42 is insertion-fit with the bracket 3. The first insert block matches with the first slot, and the second insert block matches with the second slot, the mounting plate can be positioned well before welding, which has advantages of good installation accuracy and convenient operation.

The hook plate 43 includes a straight plate portion 431 located at an upper end thereof and a claw portion 432 located at a lower end thereof. The second adjustment component 6 includes a strip groove 61 and a second bolt 62. The strip groove 61 is vertically arranged on the straight plate portion 431, and the second bolt 62 passes through the strip groove 61 and is thread-fit with the mounting plate 42. After loosening the second bolt, the hook plate is manually adjusted and change a position of the strip groove relative to the second bolt, thus, the installation height of the hook plate on the mounting plate can be adjusted.

A gasket 63 is provided between the second bolt 62 and the strip groove 61. A side surface where the gasket 63 contacts with the strip groove 61 is a spherical surface and a surface where the gasket 63 contacts with the second bolt 62 is a planar surface. Even if the straight plate portion tilts under an action of the first adjustment component, the second bolt can play a role of firmly fixing.

The first adjustment component includes a first bolt 7 that is thread-fit with the upper end of the straight plate portion 431. An end of the first bolt 7 is in contact-fit with a side wall of the mounting plate 42, and the side wall of the mounting plate 42 is inclined, and the end of the first bolt 7 is a spherical surface, the mounting plate 42 is provided with a groove 424 that is in contact-fit with the end of the first bolt 7. In a condition that the mounting plate is fixed, and the first bolt is rotated, the angle of the straight plate is changed through a thread-fit between the first bolt and the straight plate portion so as to adjust a tilt angle of the hook plate. The groove can limit an end of the first screw. Thus, the first screw is limited within a range of the groove, thereby greatly improving an operation stability of the first adjustment component.

Furthermore, the end surface of the first bolt is a spherical surface, which can reduce wear on the mounting plate.

Moreover, a combination of the first adjustment component and the second adjustment component of this embodiment can achieve multiple installation modes of the hook plate, as shown in FIG. 6, which discloses a state of the hook plate at different installation heights and tilt angles, so that the hook mechanism of this embodiment can adapt to rooves of respective car model.

A side wall of the straight plate portion 431 is provided with a first nut 433 that is fixedly installed and is thread-fit with the first bolt 7, and the side wall of the mounting plate 42 is provided with a second nut 423 that is fixedly installed and is thread-fit with the second bolt 62. The first nut and the second nut are fixed by welding, and can also be an integrated structure.

In this embodiment, after the hook plate hooks onto the hook groove of the door frame or door edge, the base plate adheres to the roof surface and automatically adjusts a suitable angle. Then, the second bolt is rotated by a tool to gradually approach the mounting plate, and the first bolt is rotated by a tool. The first bolt exerts a force on the mounting plate during a rotation process, and the mounting plate applies a reaction force to the upper end of the hook plate, thus the upper end of the hook plate moves gradually away from the mounting plate, while at the same time, the lower end of the hook plate firmly hooks the hook groove on the door frame or door edge due to the lever principle, which has the advantages of easy operation and firm installation.

The shell 2 includes a front cover plate 21 and a rear cover plate 22. One side of the front cover plate 21 is provided with a locking component 23. A position of the rear cover plate 22 corresponding to the locking component 23 is provided with a limit plate 24. The limit plate 24 is provided with a passing hole 25, a circumferential of an end of the locking component 23 is provided with a first stepped platform 26 that extends outwardly. The locking component 23 has a first state where the first stepped platform 26 passes through the limit plate 24 after being aligned with the passing hole 25, and a second state where the first stepped platform 26 does not pass through the limit plate 24 after being misaligned with the passage hole 25. The locking component needs a key to rotate. In this embodiment, the locking component is rotated by the key. After 90° rotation, the first stepped platform is aligned with the passing hole, and an operator can separate the front cover plate and rear cover plate. Conversely, when the first stepped platform is misaligned with the passing hole, the front cover plate is snap-fit with the rear cover plate, and the front cannot be separated from the rear cover plate.

Another side of the front cover plate 21 is provided with a second stepped platform 27, and another side of the rear cover plate 22 is provided with a second groove 28 that is snap-fit with the second stepped platform 27; since the locking mechanism is installed on one side of the shell, it is easy to generate a gap on another side of the shell, which affects operation stability. Thus, the second stepped platform and the second groove are installed on the another side of the shell to ensure a stable connection between the front cover plate and rear cover plate.

A position of rear cover plate 22 corresponding to the mounting plate 42 is provided with an avoidance groove 29 to prevent interference when adjusting an angle of the base plate.

In the description of the present disclosure, it should be noted that terms “center”, “vertical”, “transverse”, “up”, “down”, “front”, “back”, “left”, “right”, “upright”, “horizontal”, “top”, “bottom”, “inside”, “outside”, etc. indicate an orientation or a position relationship based on the orientation or position relationship shown in the drawings, only for the convenience of describing the present disclosure and simplifying the description, rather than indicating or implying that the device or component referred to must have a specific orientation, be constructed and operated in a specific orientation, thus it cannot be understood as a limitation of the present disclosure. In addition, terms “first” and “second” are only used to describe a purpose and cannot be understood as indicating or implying a relative importance.

In the description of the present disclosure, it should be noted that unless otherwise specified and limited, the terms “install”, “connection”, and “connect” should be understood broadly, for example, they can be a fixed connection, a detachable connection, or an integrated connection, a mechanical connection, an electrical connection, a direct connection, or an indirect connection through an intermediate medium, or it can be an internal connection between two components. For skilled person in the art, a specific meaning of the above terms in the present disclosure can be understood in a specific circumstance. In addition, in the description of the present disclosure, unless otherwise specified, the meaning of “multiple” refers to two or more.

Those skilled in the art should be noted that: although the present disclosure has been described according to the above specific embodiments, an inventive idea of the present disclosure is not limited to the present disclosure. Any modification that applies the inventive idea will be included in the protection scope of the present disclosure.

What is claimed is:

1. A roof crossbar bracket, comprising a crossbar (1), a clamping device installed at both ends of the crossbar (1) and being capably of adjusting a distance, and a shell (2) partially wrapping the clamping device, wherein, the clamping device comprises a bracket (3), a hook mechanism (4) installed on the bracket (3), and a locking mechanism (5);
wherein, the hook mechanism (4) comprises a base plate (41) installed below the bracket (3), a mounting plate (42) fixedly installed within the bracket (3), and a hook plate (43) movably installed with the mounting plate (42), the hook plate (43) is located on one side of the base plate (41), a first adjustment component (6) for adjusting an angle between the hook plate (43) and the mounting plate (42) is provided between the hook plate and the mounting plate, and a second adjustment component (6) for adjusting an installation height of the hook plate (43) on the mounting plate (42).

2. The roof crossbar bracket according to claim 1, wherein, an upper surface of the base plate (41) is provided with a mounting member (411) that is vertically arranged, the mounting member (411) is rotatably installed at a bottom of the bracket (3), and a lower surface of the base plate (41) is provided with a soft pad (413).

3. The roof crossbar bracket according to claim 1, wherein, a third bolt (414) and a third nut (412) for connecting the mounting member (411) and the bracket (3) are provided between a bottom of the mounting member (411) and the bracket (3), wherein, the third nut (412) is a self-locking nut or a welding nut.

4. The roof crossbar bracket according to claim 1, wherein, an upper end of the mounting plate (42) is provided with a first insertion block (421) and both side of the mounting plate (42) are provided with a respective second insertion block (422), and an upper surface of the bracket (3) is provided with a first slot (31) that corresponds to the first insertion block (421), and both sides of the bracket (3) are provide with a respective second slot (32) that corresponds to the second insertion block (422), the mounting plate (42) and the bracket (3) are fixed by welding after the mounting plate (42) being insertion-fit with the bracket (3).

5. The roof crossbar bracket according to claim 1, wherein the hook plate (43) comprises a straight plate portion (431) located at an upper end thereof and a claw portion (432) located at a lower end thereof, the second adjustment component (6) comprises a strip groove (61) and a second bolt (62), and the strip groove (61) is vertically arranged on the straight plate portion (431), the second bolt (62) passes through the strip groove (61) and is thread-fit with the mounting plate (42).

6. The roof crossbar bracket according to claim 5, wherein, a gasket (63) is provided between the second bolt (62) and the strip groove (61), and a side surface where the gasket (63) contacts with the strip groove (61) is a spherical surface and a surface where the gasket (63) contacts with the second bolt (62) is a planar surface.

7. The roof crossbar bracket according to claim 5, wherein the first adjustment component comprises a first bolt (7) that is thread-fit with the upper end of the straight plate portion (431), an end of the first bolt (7) is in contact-fit with a side wall of the mounting plate (42), the side wall of the mounting plate (42) is inclined, and the end of the first bolt (7) is a spherical surface, the mounting plate (42) is provided with a groove (424) that is in contact-fit with the end of the first bolt (7).

8. The roof crossbar bracket according to claim 7, wherein, a side wall of the straight plate portion (431) is provided with a first nut (433) that is fixedly installed and is thread-fit with the first bolt (7), and the side wall of the mounting plate (42) is provided with a second nut (423) that is fixedly installed and is thread-fit with the second bolt (62).

9. The roof crossbar bracket according to claim 2, wherein, the shell (2) comprises a front cover plate (21) and a rear cover plate (22), wherein one side of the front cover plate (21) is provided with a locking component (23), and a position of the rear cover plate (22) corresponding to the locking component (23) is provided with a limit plate (24), and the limit plate (24) is provided with a passing hole (25), a circumferential of an end of the locking component (23) is provided with a first stepped platform (26) that extends outwardly, the locking component (23) has a first state where the first stepped platform (26) passes through the limit plate (24) after being aligned with the passing hole (25), and a second state where the first stepped platform (26) does not pass through the limit plate (24) after being misaligned with the passing hole (25).

10. The roof crossbar bracket according to claim 9, wherein, another side of the front cover plate (21) is provided with a second stepped platform (27), and another side of the rear cover plate (22) is provided with a second groove (28) that is snap-fit with the second stepped platform (27);
a position of rear cover plate (22) corresponding to the mounting plate (42) is provided with an avoidance groove (29).
